(19) United States
(12) Patent Application Publication
(10) Pub. No.: US 2025/0368451 A1
(43) Pub. Date: Dec. 4, 2025

(54) Deformable conveyor

(71) Applicant: INSTITUT NATIONAL DE RECHERCHE EN INFORMATIQUE ET EN AUTOMATIQUE, Le Chesnay (FR)

(72) Inventors: Thor Bieze, LE CHESNAY (FR); Eulalie Coevoet, LE CHESNAY (FR); Alexandre Kruszewski, LE CHESNAY (FR); Christian Duriez, LE CHESNAY (FR)

(21) Appl. No.: 18/875,877

(22) PCT Filed: Jun. 21, 2023
(86) PCT No.: PCT/EP2023/066852

§ 371 Date: Dec. 17, 2024

(30) Foreign Application Priority Data
Jun. 22, 2022 (FR) FR2206157

(51) Int. Cl. B65G 35/00; B25J 9/10; B25J 9/14; B25J 15/00; B65G 15/14; B65G 47/24

(52) U.S. Cl. CPC B65G 35/005; B25J 9/1045; B25J 9/142; B25J 15/0004; B65G 15/14; B65G 47/24; B65G 2201/0211

(57) ABSTRACT

A pick-and-place device including a deformable robot designed to be arranged proximate to a picking area and a placement area. The deformable robot includes a first handling end, at which the deformable robot picks up an object in the picking area, and a second handling end, at which the deformable robot places an object in the placement area. The first handling end is able to be moved in the picking area, or the second handling end is able to be moved in the placement area. The deformable robot further comprises a deformable conveying structure connecting the first handling end and the second handling end so as to convey an object picked up by the first handling end up to the second handling end.

### CROSS-REFERENCE TO RELATED APPLICATIONS

This Application is a Section 371 National Stage Application of International Application No. PCT/EP2023/066852, filed Jun. 21, 2023, and published as WO 2023/247644 A1 on Dec. 28, 2023, not in English, which claims priority to and the benefit of French Patent Application No. 2206157, filed Jun. 22, 2022, the contents of which are incorporated herein by reference in their entireties.

### FIELD OF THE DISCLOSURE

The invention relates to the field of robotic installations for moving objects.

### BACKGROUND

Typically, these robotic installations pick up an object in a picking area, for example on a first production line or a storage area, and place this object in a placement area, for example on a second production line or in a cardboard box.

A first type of robotic installations is known, these are referred to as “pick-and-place robots”. In general, a pick-and-place robot has one single rigid articulated arm, at the end of which there is a gripping member. Typically, in this first type of robotic installations, when the gripping member grasps an object in the picking area, the articulated arm executes a rotational and/or translational movement so that this gripping member reaches the placement area and places the object therein. Pick-and-place robots are not always suitable for handling objects that are fragile or have variable dimensions, as found in particular in the agri-food industry. Furthermore, the use of these robots requires a restrictive arrangement of their workspace, because of the danger that the high speed of their movements represents for human safety.

A second type of robotic installations is known, which are referred to as “cobots” or “collaborative robots”. Collaborative robots are equipped with devices, such as presence detection devices, allowing making them operate in collaboration with human operators or proximate to them. However, the activation of these devices considerably slows down operation thereof. Thus, collaborative robots are not very suitable for high cycling rates required in some industries, like the agri-food industry. Furthermore, these robots also are not always well suitable for handling objects that are fragile or have variable dimensions.

It is desired to design a robotic installation for moving objects which is compatible with handling of objects that are fragile or have variable dimensions, and at the same time with high production rates, while remaining safe.

### SUMMARY

The invention improves the situation. To this end, a pick-and-place device is provided, comprising a deformable robot designed so as to be arranged proximate to a picking area and a placement area. The deformable robot comprises a first handling end, at which the deformable robot picks up an object in the picking area, and a second handling end, at which the deformable robot places an object in the placement area. The first handling end is able to be moved in the picking area, or the second handling end is able to be moved in the placement area. The deformable robot further comprises a deformable conveying structure connecting the first handling end and the second handling end so as to convey an object picked up by the first handling end up to the second handling end.

Thus, the arrangement of the deformable conveying structure between the first handling end and the second handling end allows maintaining a high operating rate without requiring rapid and hazardous movements.

This device is particularly advantageous because it can be made from soft structures, such as belts or peristaltic movement structures, which enables handling of objects that are fragile or have variable dimensions.

According to various embodiments, the invention may have one or more of the following features:
the deformable conveying structure comprises a deformable channel;
the deformable channel comprises a pair of tensioning arms, held at a substantially constant distance from each other, and the deformable conveying structure comprises a pair of belts, each arranged on one of the tensioning arms, these belts, being able to clasp an object therebetween and to drive the latter from the first handling end up to the second handling end;
the deformable conveying structure comprises cables, positioned along the tensioning arms, and an actuator connected to said cables and designed so as to deform the deformable conveying structure by varying the tension of these;
the deformable channel comprises a plurality of tensioning arms (for example three), connected to each other proximate to the first handling end or the second handling end, and the deformable conveying structure comprises a plurality of belts (for example three), each arranged on a respective tensioning arm, these belts being able to clasp together an object and to drive the latter from the first handling end up to the second handling end;
the pick-and-place device comprises a slide and the deformable conveying structure comprises an actuator connected to said slide and designed so as to deform the deformable conveying structure by translating one of the tensioning arms along the slide;
the pick-and-place device is able to modify the orientation of an object conveyed in the deformable channel;
at least one belt is deformable according to a direction transverse to the local drive direction of said belt;
the deformable conveying structure comprises a peristaltic movement structure connected to the deformable channel;
the peristaltic movement structure comprises peristaltic rings, each peristaltic ring having a row of inflatable actuators;
the first handling end or the second handling end has a flared shape;
the first handling end or the second handling end has a gripping actuator.

### BRIEF DESCRIPTION OF THE DRAWINGS

Other features and advantages of the invention will appear better upon reading the following description, derived from examples given for illustrative and non-limiting purposes, and from the drawings wherein:

FIG. 1 is a top view of a pick-and-place device according to a first embodiment of the invention, executing an object conveying operation;

FIG. 2 shows a result of the conveying operation of FIG. 1, in three-quarter view;

FIG. 3 is a three-quarter view of an embodiment of the deformable robot of the device of FIGS. 1 and 2, in the absence of belts;

FIG. 4 is a top view of a pick-and-place device according to a second embodiment of the invention;

FIG. 5 is a three-quarter view of a scenario of the device of FIG. 1 and of the device of FIG. 4 operating together;

FIG. 6 is a three-quarter view of a pick-and-place device according to a third embodiment of the invention, in an object rotation operation;

FIG. 7 is a three-quarter view of a pick-and-place device according to a fourth embodiment of the invention, in an object rotation operation;

FIG. 8 shows a first position of a pick-and-place device according to a fifth embodiment, in a three-quarter view;

FIG. 9 is similar to FIG. 8, the device being in a second position;

FIG. 10 shows a pick-and-place device according to a sixth embodiment, in a three-quarter view;

FIG. 11 is a front view of a pick-and-place device according to a seventh embodiment, in a first position;

FIG. 12 is a side view of the device of FIG. 11;

FIG. 13 is similar to FIG. 12, the device being in a second position;

FIG. 14 is a three-quarter view of a pick-and-place device according to an eighth embodiment of the invention;

FIG. 15 shows the peristaltic movement structure of the device of FIG. 14 in a first object conveying step, in an enlarged side view;

FIG. 16 shows the peristaltic movement structure of FIG. 15 in a second object conveying step;

FIG. 17 shows the peristaltic movement structure of FIG. 15 in a third object conveying step.

### DETAILED DESCRIPTION OF ILLUSTRATIVE EMBODIMENTS

The drawings and the following description essentially contain elements of certain nature. Hence, they could not only be used to better understand the present invention but also contribute to the definition thereof, where appropriate.

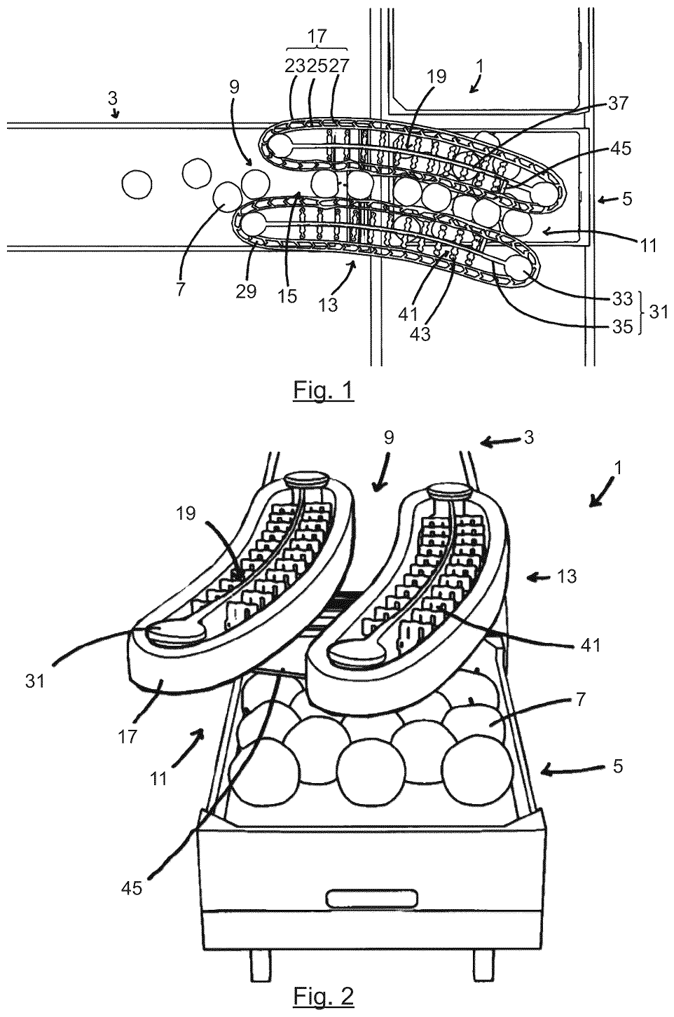

Reference is made to FIGS. 1 and 2.

FIG. 1 is a top view of a pick-and-place device according to a first embodiment of the invention, executing an object conveying operation. FIG. 2 shows a result of the object conveying operation of FIG. 1, in three-quarter view.

This pick-and-place device comprises a deformable robot 1, arranged between a picking area 3, herein a first conveyor belt, and a placement area 5, herein a crate transported on a second conveyor belt. The first conveyor belt and the second conveyor belt are respectively arranged according to a first conveying plane and a second conveying plane. In this case, to simplify the explanation, the first conveying plane and the second conveying plane are substantially horizontal, but the first conveying plane and the second conveying plane could be inclined. The first conveyor belt and the second conveyor belt respectively extend according to a first conveying direction and a second conveying direction. The first conveying direction and the second conveying direction together form an angle, herein substantially 90°. In this case, the second conveyor belt is located under the first conveyor belt. In this case, the deformable robot 1 is attached to the structure of the first conveyor belt and partly overhangs the second conveyor belt.

The deformable robot 1 moves objects 7, herein apples, from the picking area 3 up to the placement area 5. In this case, the deformable robot 1 moves several apples simultaneously. The deformable robot 1 comprises a first handling end 9 and a second handling end 11, opposite one another, and a deformable conveying structure 13, which connects the first handling end 9 to the second handling end 11. The deformable robot 1 picks up the objects 7 in the picking area 3 with the first handling end 9. The deformable robot 1 places the objects 7 in the placement area 5 with the second handling end 11. In this case, the first handling end 9 has a flared shape, so as to progressively guide the objects 7 from the picking area 3 towards the deformable conveying structure 13. In this case, the second handling end 11 has a flared shape, so as to progressively release the objects 7 in the placement area 5.

The deformable conveying structure 13 deforms so as to convey the objects 7 picked up by the first handling end 9 up to the second handling end 11.

The arrangement of the deformable conveying structure 13 between the first handling end 9 and the second handling end 11 allows maintaining a high cycling rate without the need for rapid and hazardous movements of the deformable robot 1.

In this first embodiment, the deformable conveying structure 13 deforms so as to move the second handling end 11 within the placement area 5.

The deformable conveying structure 13 has a deformable channel 15. The deformable channel 15 is elongated between the first handling end 9 and the second handling end 11. In this case, the deformable channel 15 extends from the first handling end 9 up to the second handling end 11. The deformable channel 15 forms a pipe for the objects 7.

In this first embodiment, the deformable conveying structure 13 comprises a pair of belts 17 and the deformable channel 15 is formed by a pair of tensioning arms 19. Each belt 17 is arranged around one of the tensioning arms 19. The belts 17 transmit a translational movement so as to convey objects 7 along the deformable conveying structure 13. The belts 17 clasp the objects 7 therebetween so as to hold these objects 7 in the deformable channel 15 while they are conveyed along the deformable conveying structure 13. When an object 7 is picked up with the first handling end 9, the belts 17 clasp this object 7 therebetween and drive it from the first handling end 9 up to the second handling end 11.

The use, in the deformable conveying structure 13, of soft structures, such as the belts 17, enables the deformable robot 1 to handle objects 7 that are fragile or have variable dimensions.

The deformable conveying structure 13 further comprises one or more cross-member(s) (not shown) connecting the tensioning arms 19 together, herein proximate to the second handling end 11. The cross-members pass outside the pipe formed by the deformable channel 15. The cross-members hold the tensioning arms 19 at a substantially constant spacing distance from each other. The spacing distance is determined according to the dimensions of the objects 7 to be moved.

On each belt 17, driving said belt 17 on the corresponding tensioning arm 19 defines a local drive direction. One or each of the belts 17 may be deformable according to a direction transverse to the local drive direction of said belt 17. This deformation of one or each of the belts 17 distributes the contact forces over the held object 7. This deformation of one or each of the belts 17 allows holding objects 7 that are fragile or have variable dimensions between the belts 17. In this case, each belt 17 is deformable according to the direction transverse to the local drive direction of said belt 17.

One or both of said belts 17 may have one or more strand(s). The strands may be made of a similar or different material. In this case, each belt 17 comprises two strands. In this case, the two strands are flat strips 23, 25. In this case, the flat strips 23, 25 are made of a very soft material.

The flat strips 23, 25 are endless. The flat strips 23, 25 of the same belt 17 have different lengths. On each belt 17, the flat strips 23, 25 are arranged so that the longest one, so-called the outer flat strip 23, encircles the shortest one, so-called the inner flat strip 25. The outer flat strips 23 are in contact with the objects 7 to be moved. The inner flat strips 25 are in contact with the tensioning arms 19. In this case, the inner flat strip 25 is made of rubber and the outer flat strip 23 is made of elastomer.

In this case, each belt 17 further comprises a set of fasteners 27 connecting the flat strips 23, 25 together. In this case, each belt 17 comprises forty fasteners 27. The fasteners 27 may be made of the same material as that of the flat strips 23, 25 or of a material different from the latter. In this case, each fastener 27 has two portions, with a generally rectangular shape, which are arranged so as to form a “V” with one another when the deformable robot 1 is viewed from above. In this case, the fasteners 27 are arranged between the flat strips 23, 25 so that all “V”s are positioned in the same direction on a same belt 17.

The flat strips 23, 25 and the fasteners 27 together delimit a series of hollow cells 29. In this case, on each belt 17, the two flat strips 23, 25 and the forty fasteners 27 delimit forty hollow cells 29. The hollow cells 29 are deformable. In this case, the hollow cells 29 have a cylinder shape with a hexagonal base. When an object 7 is picked up with the first handling end 9, said object 7 comes into contact with the outer flat strips 23 of the belts 17. On each belt 17, the hollow cells 29 located proximate to the object 7 deform, elastically, according to a direction transverse to the local drive direction of the belt 17. This deformation of the hollow cells 29 ensures holding of the object 7 between the belts 17 while distributing the contact forces over the object 7. The hollow cells 29 recover their shape once the object 7 has reached the second handling end 11.

The belt 17 model is described hereinabove as example. Other belt 17 models are possible.

Each tensioning arm 19 comprises a tensioning block 31 at each of its ends. Each of the tensioning blocks 31 comprises a central portion 33, herein having a substantially cylindrical shape. Each of the central portions 33 of the tensioning blocks 31 has a pulley. On each tensioning arm 19, one of the belts 17 is tensioned between the pulleys of the tensioning blocks 31 of said tensioning arm 19. On each tensioning arm 19, one or more motor(s) (not shown) transmit(s) a rotational movement to the belt 17 tensioned between the pulleys of the tensioning blocks 31 of said tensioning arm 19 and drive the latter.

Each tensioning block 31 further comprises a radial portion 35 projecting from the central portion 33 of said tensioning block 31.

Each tensioning arm 19 comprises a soft body 37 connecting the radial portions 35 of the tensioning blocks 31 together. In this case, the soft body 37 has an elongate and substantially rectangular shape.

Each tensioning arm 19 further comprises pairs of feet 41 supported by the soft body 37. In this case, the feet 41 of the same pair are arranged at a regular interval along the soft body 37. In this case, the feet 41 are fastened to the soft body 37 in a rigid manner and substantially perpendicular to the latter. In this case, each soft body 37 supports eleven pairs of feet 41.

Each foot 41 carries a pair of rollers 43, at a distance from the soft body 37. On each tensioning arm 19, the pairs of rollers 43 contribute to the alignment of the belt 17 arranged around said tensioning arm 19 and hold said belt 17 substantially parallel to said tensioning arm 19. In this case, on each tensioning arm 19, the rollers 43 of a same pair are arranged on either side of the inner flat strip 25 of the belt 17 positioned around said tensioning arm 19 and serve as a guide for said inner flat strip 25.

The deformable conveying structure 13 comprises a first actuator (not shown), capable of moving and deforming said deformable conveying structure 13. In this case, the first actuator makes the tensioning blocks 31 arranged at the first handling end 9 translate along respective slides (not shown). Alternatively, the first actuator may be connected to only one of said tensioning blocks 31. In this case, the slideways extend according to a direction generally parallel to the first conveying direction.

The first actuator can make said tensioning blocks 31 perform the same translational movement. In this case, the deformable robot 1 moves according to the direction generally parallel to the first conveying direction.

The first actuator can make one of said tensioning blocks 31 perform a relative translational movement relative to the other one of said tensioning blocks 31, according to the direction generally parallel to the first conveying direction. In this case, the tensioning arms 19 bend, because these are held by the cross-members at a substantially constant spacing distance from each other. The deformable conveying structure 13 deforms, herein in a plane substantially parallel to the first conveying plane. The second handling end 11 moves within the placement area 5 accordingly.

The first handling end 9 may comprise a second actuator, so-called the first gripping actuator. Said first gripping actuator modifies an opening angle of the first handling end 9 so as to accurately pick up an object 7.

The second handling end 11 may comprise, like in this case, a third actuator, so-called the second gripping actuator. Said second gripping actuator modifies an opening angle of the second handling end 11 so as to accurately release an object 7. In this case, when an object 7 conveyed by the deformable conveying structure 13 reaches the second handling end 11, the second gripping actuator separates the tensioning blocks 31 from each other at said second handling end 11.

The deformable conveying structure 13 may comprise, like in this case, a motor-driven stop 45. In this case, the motor-driven stop 45 connects the tensioning arms 19 together from below, proximate to the second handling end 11. In this case, the motor-driven stop 45 extends according to a stop axis and has a generally cylindrical shape. The motor-driven stop 45 rotates about itself about its stop axis. In this case, when an object 7 conveyed in the deformable channel 15 comes into contact with the motor-driven stop 45, the rotation of the latter about its stop axis modifies the orientation of said object 7.

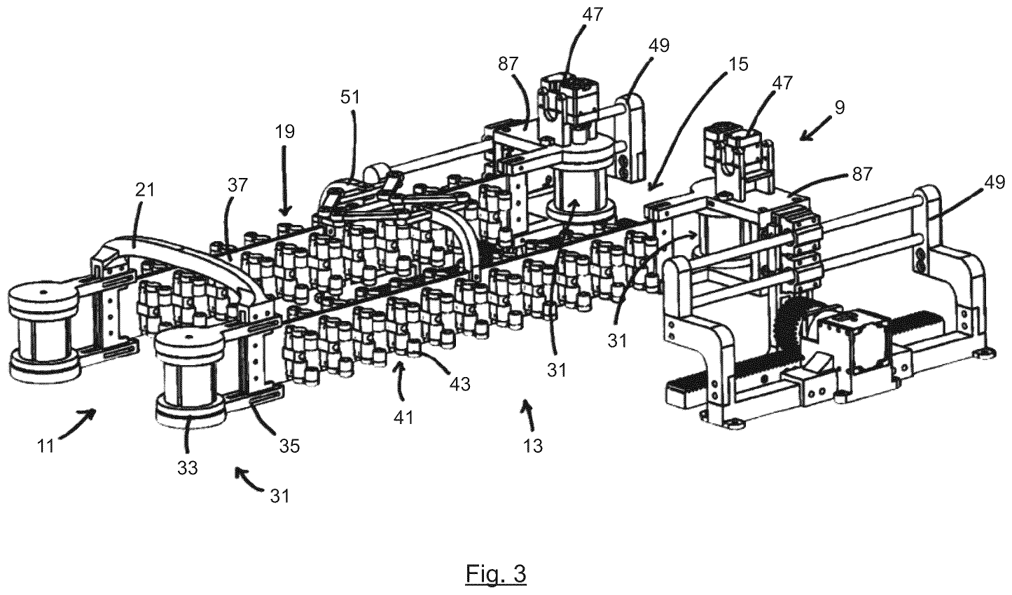

Reference is made to FIG. 3.

This figure shows a three-quarter view of an embodiment of the deformable robot 1 of the device of FIGS. 1 and 2, in the absence of belts. The portions of the deformable robot 1 in accordance with what has been described before for FIGS. 1 and 2 are not described again.

In this embodiment, the cross-member 21 connecting the tensioning arms 19 together circumvents the pipe formed by the deformable channel 15 from above. In this case, the cross-member 21 connects the radial portions 35 of the tensioning blocks 31 arranged at the second handling end 11.

Each of the tensioning blocks 31 arranged at the first handling end 9 has a projecting portion 87, herein extending substantially perpendicularly with respect to its radial portion 35. The projecting portions 87 deviate from said tensioning blocks 31 so as to clear a space for passage of the belts. The projecting portions 87 extend away from the pipe formed by the deformable channel 15.

The motors 47 transmitting a rotational movement to the belts 17 are fastened above the tensioning blocks 31 arranged at the first handling end 9. Each motor 47 is positioned astride the central portion 33 and the projecting portion 87 of the associated tensioning block 31.

The slides 49 are positioned on either side of the deformable robot 1, proximate to the first handling end 9. The first actuator is connected to the slides 49 via rack mechanisms. Each slide 49 comprises two rails, along which linear translation guides, fastened to the projecting portion 87 of one of the tensioning blocks 31 arranged at the first handling end 9, slide.

In this embodiment, the tensioning arms 19 are also connected together by a hinged arch 51, herein substantially halfway through the deformable channel 15. In this case, the hinged arch 51 circumvents the pipe formed by the deformable channel 15 from above. The hinged arch 51 contributes to holding of the tensioning arms 19 at a substantially constant spacing distance from one another during the deformation of the deformable conveying structure 13.

In this case, the first handling end 9 and the second handling end 11 are deprived of gripping actuators. In this case, the deformable conveying structure 13 is deprived of a motor-driven stop.

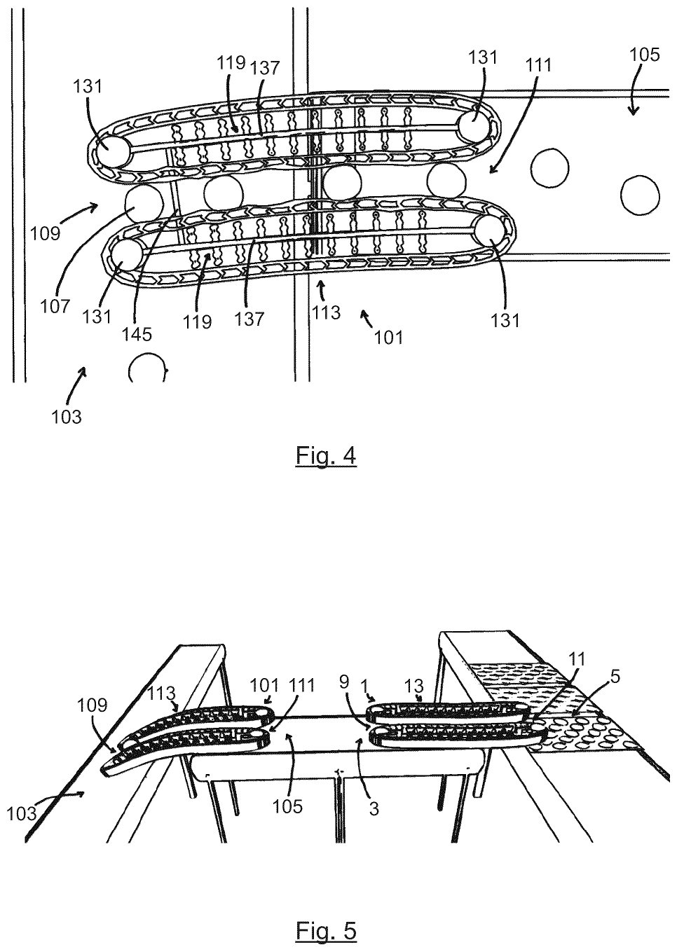

Reference is made to FIG. 4.

This figure shows a pick-and-place device according to a second embodiment, in top view. Elements that are functionally similar to those described in the first embodiment bear identical reference numerals increased by one hundred.

In this second embodiment, the deformable robot 101 is substantially similar to that one described in the first embodiment, except that the deformable conveying structure 113 of said deformable robot 101 deforms so as to move the first handling end 109 within the picking area 103, and not so as to move the second handling end 111 within the placement area 105.

In this case, the picking area 103 is a first conveyor belt and the placement area 105 is a second conveyor belt. The first conveyor belt and the second conveyor belt are respectively arranged according to a first conveying plane and a second conveying plane. In this case, to simplify the explanation, the first conveying plane and the second conveying plane are substantially horizontal, but the first conveying plane and the second conveying plane could be inclined. The first conveyor belt and the second conveyor belt respectively extend according to a first conveying direction and a second conveying direction. The first conveying direction and the second conveying direction together form an angle, herein substantially 90°. In this case, the first conveyor belt is located under the second conveyor belt. In this case, the deformable robot 101 is attached, at its second handling end 111, to the structure of the second conveyor belt. In this case, the soft bodies 137 of the tensioning arms 119 are pre-curved, so that the deformable robot 101 is placed, at its first handling end 109, on the first conveyor belt.

In this second embodiment, the cross-members (not shown) are positioned proximate to the first handling end 109. The first actuator actuates the tensioning blocks 131 arranged at the second handling end 111. Alternatively, the first actuator can actuate only one of said tensioning blocks 131. In this case, the simultaneous slip of said tensioning blocks 131 results in a movement of the deformable robot 101 according to a direction generally parallel to the second conveying direction. In this case, the relative sliding of one of said tensioning blocks 131 relative to the other one of said tensioning blocks 131 according to the direction generally parallel to the second conveying direction results in a movement of the first handling end 109 within the picking area 103.

In this case, the first gripping actuator of the first handling end 109 modifies the opening angle of said first handling end 109 so as to accurately pick up an object 107.

In this case, the second handling end 111 is deprived of a gripping actuator. In this case, the motor-driven stop 145 is positioned proximate to the first handling end 109.

Reference is made to FIG. 5.

This figure shows a scenario of the device of FIG. 1 and of the device of FIG. 4 operating together, in three-quarter view.

To simplify the description of this scenario, we will hereafter refer to the deformable robot 101 of the second embodiment as the first deformable robot 101, and we will refer to the deformable robot 1 of the first embodiment as the second deformable robot 1.

The first deformable robot 101 and the second deformable robot 1 are respectively positioned between a first conveyor belt and a second conveyor belt, and between the second conveyor belt and a third conveyor belt. In this case, the third conveyor belt transports packaging trays. The first conveyor belt, the second conveyor belt and the third conveyor belt are respectively arranged according to a first conveying plane, a second conveying plane and a third conveying plane. In this case, to simplify the explanation, the first conveying plane, the second conveying plane and the third conveying plane are substantially horizontal, but the first conveying plane, the second conveying plane and the third conveying plane could be inclined. The first conveyor belt, the second conveyor belt and the third conveyor belt extend according to a first conveying direction, a second conveying direction and a third conveying direction, respectively. The first conveying direction and the second conveying direction together form an angle, herein substantially 90°. The second conveying direction and the third conveying direction together form an angle, herein substantially 90°. In this case, the first conveying direction and the third conveying direction are substantially parallel. In this case, the first conveyor belt and the third conveyor belt are located under the second conveyor belt. In this case, each of the first deformable robot 101 and the second deformable robot 1 is attached to one of the ends of the structure of the second conveyor belt. The first deformable robot 101 is placed on the first conveyor belt at its first handling end 109. The first deformable robot 101 is attached to the second conveyor belt at its second handling end 111. The second deformable robot 1 is attached to the second conveyor belt at its first handling end 9. The second deformable robot 1 overhangs the third conveyor belt at its second handling end 11.

The first handling end 109 of the first deformable robot 101 is able to be moved in the picking area 103 of the latter. The second handling end 11 of the second deformable robot 1 is able to be moved in the placement area 5 of the latter.

In this scenario, the first deformable robot 101 accurately picks up at its first handling end 109 an object in its picking area 103, herein the first conveyor belt. The first deformable robot 101 conveys the object up to its second handling end 111. Afterwards, the first deformable robot 101 places the object in its placement area 105, herein an end of the second conveyor belt. The object is transported by the second conveyor belt up to its other end, which forms the picking area 3 of the second deformable robot 1. The second deformable robot 1 then picks up the object at its first handling end 9 and conveys the latter up to its second handling end 11. Finally, the second deformable robot 1 accurately places the object in its placement area 5, herein a packaging tray transported by the third conveyor belt.

This scenario allows transporting objects from one production line, herein the first conveyor belt, to another production line, herein the third conveyor belt, in a rapid, accurate and safe manner.

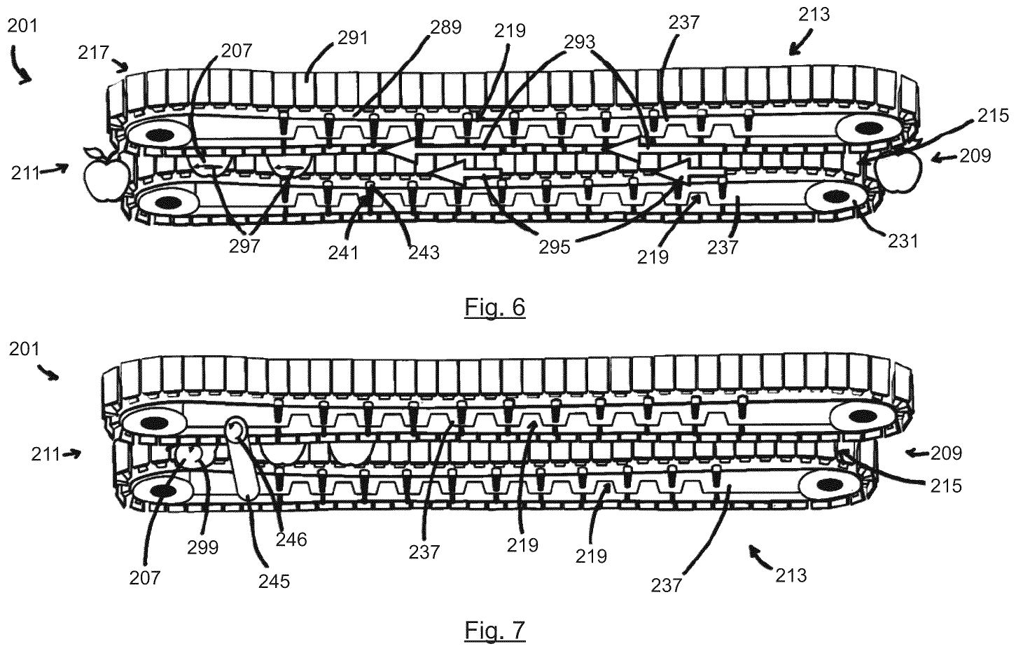

Reference is made to FIG. 6.

This figure is a three-quarter view of a pick-and-place device according to a third embodiment of the invention, during an object rotation operation.

Elements that are functionally similar to those described in the first embodiment bear identical reference numerals increased by two hundreds.

In this third embodiment, the deformable robot 201 is substantially similar to that one described in the first embodiment, except that the deformable conveying structure 213 of said deformable robot 201 is deprived of motor-driven stops and has models of belts 217 and soft bodies 237 of tensioning arms 219 substantially different from those described in the first embodiment.

For simplicity, the radial portions of the tensioning blocks 231 are not shown.

In this third embodiment, each belt 217 has one single strand, which comprises a flat strip 289 and a set of cushions 291 fastened on said flat strip 289.

The flat strips 289 are substantially similar to the inner flat strips of the belts described in the first embodiment. The flat strips 289 are endless. The flat strips 289 are in contact with the tensioning arms 219. In this case, on each tensioning arm 219, the rollers 243 of the same pair are arranged on either side of the flat strip 289 of the belt 217 positioned around said tensioning arm 219 and serve as a guide for said flat strip 289. In this case, the flat strips 289 are made of rubber or another soft polymer, possibly reinforced with textile fibres.

The cushions 291 are in contact with the objects 207 to be moved. In this case, each cushion 291 supports a platform, via which said cushion 291 is in contact with the objects 207 to be moved. In this case, said platforms have a generally rectangular shape. On each flat strip 289, the cushions 291 are arranged so that the platforms of said cushions 291 are contiguous. In this case, each cushion 291 is generally shaped as a truncated pyramid with a rectangular base, which widens from the end of said cushion 291 fastened on one of the flat strips 289 in the direction of the platform supported by said cushion 291. The cushions 291 are made of a soft polymer material, for example made of silicone or of a soft plastic.

The model of the cushions 291 is described hereinabove as example. Other models of cushions are possible, which have for example a geometry specifically adapted to a given type of objects with a homogeneous shape, transported in an industrial context.

The cushions 291 deform in a manner substantially similar to that one described for the hollow cells delimited by the belts in the first embodiment. When an object 207 is picked up with the first handling end 209, said object 207 comes into contact with the cushions 291 of the belts 217. On each belt 217, the cushions 291 located proximate to the object 207 deform elastically according to a direction transverse to the local drive direction of the belt 217. This deformation of the cushions 291 ensures holding of the object 207 between the belts 217 while distributing the contact forces over the object 207. The cushions 291 recover their shape once the object 207 has reached the second handling end 211.

The soft bodies 237 of the tensioning arms 219 differ from what has been described in the first embodiment in that said soft bodies 237 have a serration, herein forming nine teeth. Each tooth supports one of the pairs of feet 241.

The deformable robot 201 modifies the orientation of the objects 207 conveyed between the first handling end 209 and the second handling end 211. In this case, the objects 207 undergo a rotation relative to the deformable robot 201. In this case, this rotation is performed about an axis perpendicular to the local drive directions of the belts 217, as represented by first arrows 297.

In the illustrated rotation operation, the rotation of the objects 207 results from a modification of the drive speed of the belts 217. The drive movement of the belts 217 is represented by second arrows 293 and third arrows 295. The second arrows 293 and the third arrows 295 have different lengths, which means that the drive speeds of the belts 217 are different. In this case, the drive speed of the belt 217 associated with the third arrows 295 is lower than that of the belt 217 associated with the second arrows 293. The second arrows 293 and the third arrows 295 are oriented in the same direction, which means that the drive directions of the belts 217 are the same. In this case, at the level of the pipe formed by the deformable channel 215 for the objects 207, the drive direction of the belts 217 is oriented from the first handling end 209 towards the second handling end 211. During this rotation operation, the objects 207 conveyed in the deformable channel 215 continue to advance from the first handling end 209 towards the second handling end 211. The objects 207 rotate about themselves, at an angular velocity which depends on the difference between the drive speeds of the belts 217. This rotation operation is particularly adapted to impart an end-of-rotation movement on the objects 207.

Alternatively, the rotation of the objects 207 may result from a modification of the drive direction of the belts 217. In this alternative rotation operation (not shown), the drive directions of the belts 217 are opposite with respect to one another. The objects 207 conveyed in the deformable channel 215 stop advancing towards the second handling end 211. The objects 207 rotate about themselves, at an angular speed which depends on the drive speeds of each of the belts 217. This alternative rotation operation is particularly adapted to impart a large rotational movement on the objects 207.

Reference is made to FIG. 7.

This figure is a three-quarter view of a pick-and-place device according to a fourth embodiment of the invention, during an object rotation operation.

Elements that are functionally similar to those described in the third embodiment bear identical reference numerals.

In this fourth embodiment, the deformable robot 201 is substantially similar to that one described in the third embodiment, except that the deformable conveying structure 213 of said deformable robot 201 is provided with the motor-driven stop 245.

In this fourth embodiment, the motor-driven stop 245 is substantially similar to that one described in the first embodiment. In this case, the motor-driven stop 245 connects the soft bodies 237 of the tensioning arms 219 together from the underside, proximate to the second handling end 211. The motor-driven stop 245 rotates about its stop axis, relative to the deformable robot 201. In this case, this rotation is done in the counterclockwise direction, as represented by a fourth arrow 246. When an object 207 conveyed in the deformable channel 215 comes into contact with the motor-driven stop 245, the rotation of the latter about the stop axis modifies the orientation of said object 207.

In this case, said object 207 undergoes a rotation about an axis parallel to the stop axis, as represented by a fifth arrow 299, relative to the deformable robot 201.

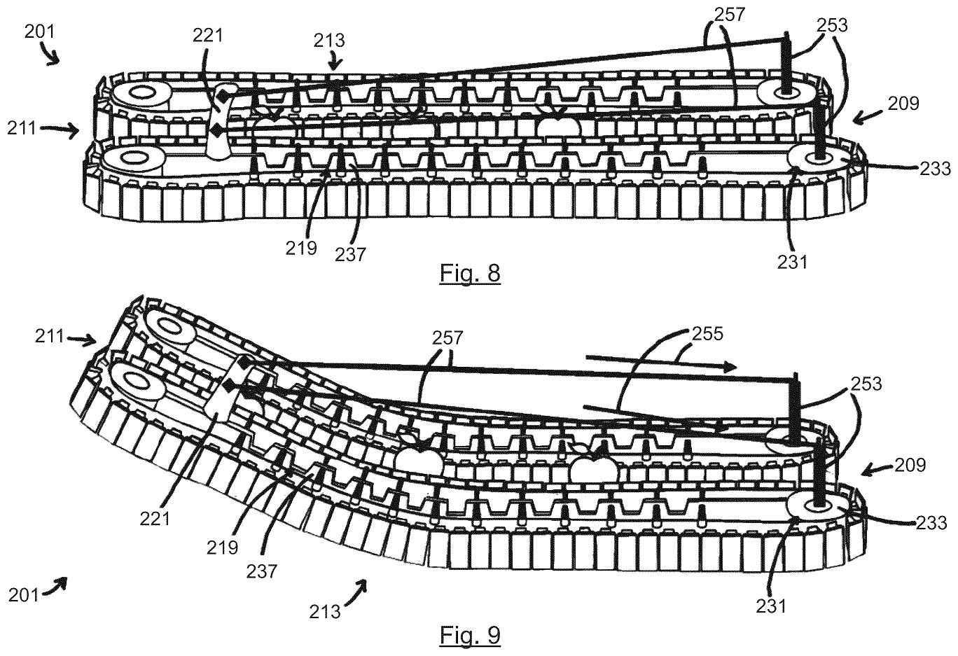

Reference is made to FIGS. 8 and 9.

These figures show a pick-and-place device according to a fifth embodiment of the invention, in a three-quarter view, in two different positions.

Elements that are functionally similar to those described in the third embodiment bear identical reference numerals.

In this fifth embodiment, the deformable conveying structure 213 is substantially similar to that one of the third embodiment, except that said deformable conveying structure 213 is able to deform according to a direction transverse to the deformable robot 201, herein a vertical direction.

In this case, the serration on the soft bodies 237 of the tensioning arms 219 enables a bending movement of the deformable robot 201 according to the vertical direction.

Each tensioning block 231 proximate to the first handling end 209 is topped by a post 253. On each tensioning block 231, the post 253 rises from the central portion 233 of said tensioning block 231, herein from the centre of the latter. In this case, the posts 253 extend according to the vertical direction, generally parallel to one another.

The deformable conveying structure 213 comprises two cables 257. The cables 257 extend along the tensioning arms 219, herein above said tensioning arms 219. In this case, each of the cables 257 connects the end of one of the posts 253 to one side of the cross-member 221.

The deformable conveying structure 213 comprises a fourth actuator, designed so as to deform said deformable conveying structure 213 according to the vertical direction. The fourth actuator is connected to the cables 257. The fourth actuator deforms the deformable conveying structure 213 by varying the tension of the cables 257. The amplitude of the resultant deformation depends on the amplitude of the variation in the tension of the cables 257. In this case, this deformation causes a movement of the second handling end 211 within the placement area, according to the vertical direction.

In the position of FIG. 8, the fourth actuator slightly pulls on the cables 257, so as to substantially keep the deformable robot 201 in a plane, herein a horizontal plane. The deformable conveying structure 213 is not deformed according to the vertical direction.

In the position of FIG. 9, the fourth actuator strongly pulls on the cables 257, as represented by sixth arrows 255. The deformable conveying structure 213 is deformed according to the vertical direction at the level of its second handling end 211. The second handling end 211 is moved accordingly, herein substantially towards the top of the figure.

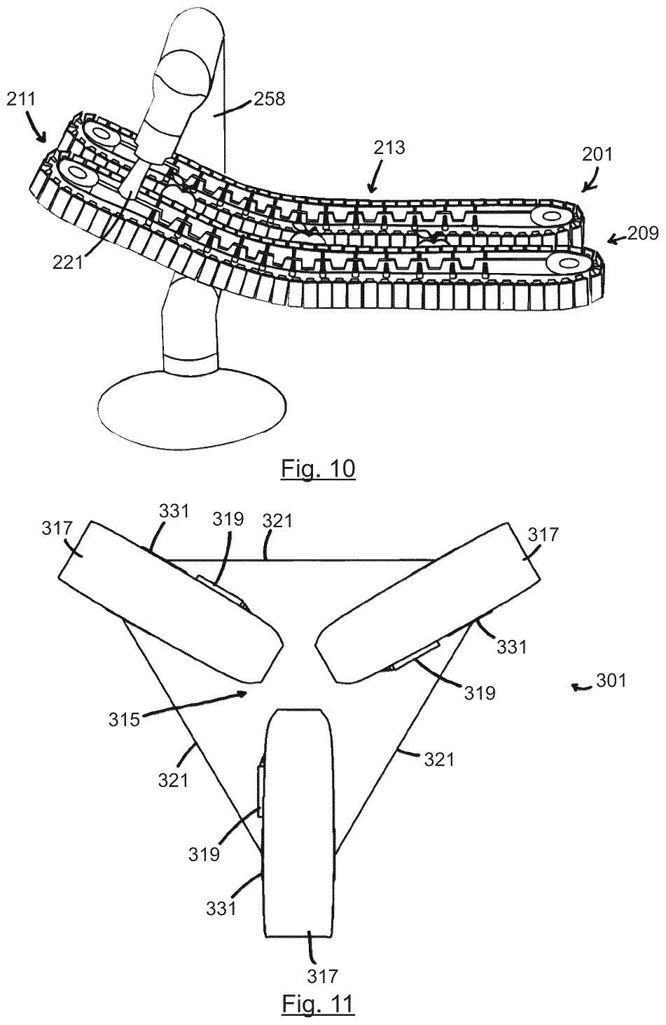

Reference is made to FIG. 10.

This figure is a three-quarter view of a pick-and-place device according to a sixth embodiment of the invention.

Elements that are functionally similar to those described in the third embodiment bear identical reference numerals.

In this sixth embodiment, the deformable robot 201 is substantially similar to that one described in the fifth embodiment, except that the device further comprises a robot arm 258, able to deform the deformable conveying structure 213 in three non-coplanar directions of space. The deformation of the deformable conveying structure 213 is no longer achieved by actuators connected to slides or to cables.

In this sixth embodiment, the deformable conveying structure 213 is deprived of the first actuator and the fourth actuator described before.

The robot arm 258 itself is known in the prior art.

In this case, the robot arm 258 is connected to the deformable robot 201 proximate to the second handling end 211. In this case, the robot arm 258 is connected to the cross-member 221. In this case, the robot arm 258 moves the second handling end 211 in the three directions of space, within the placement area.

This embodiment of the device has the advantage of improving the accuracy of the movements of the second handling end 211 of the deformable robot 201 in the three directions of space.

Reference is made to FIGS. 11, 12 and 13.

These figures show a pick-and-place device according to a seventh embodiment of the invention, in front view and in side view, in two different positions.

Elements that are functionally similar to those described in the first embodiment bear identical reference numerals increased by three hundreds.

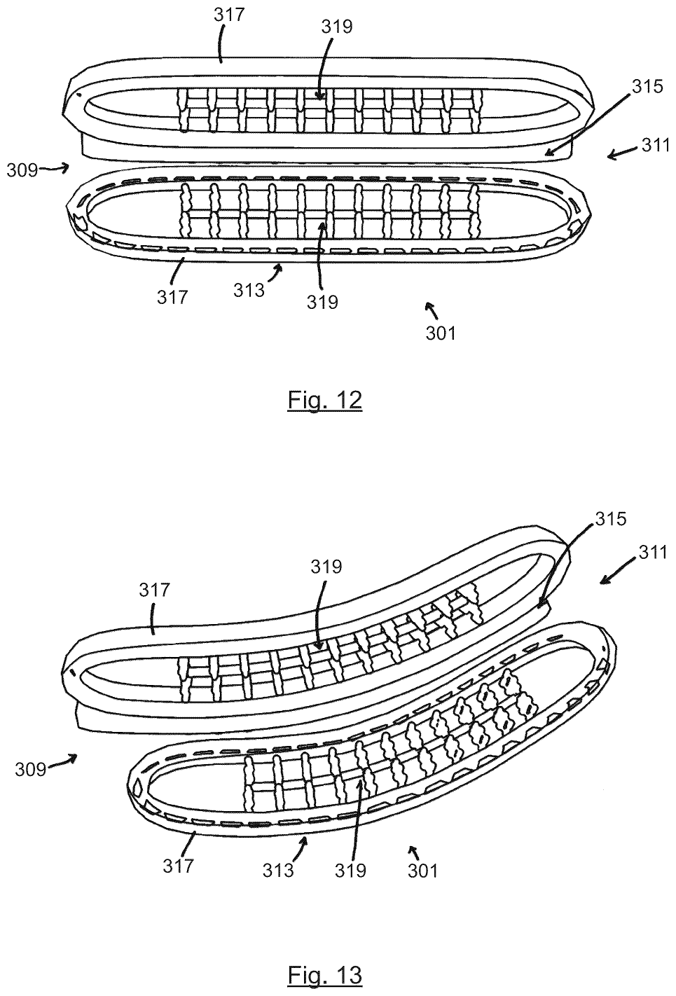

For simplicity, the deformable conveying structure 313 of the deformable robot 301 is schematically shown in FIGS. 12 and 13, with no tensioning blocks and cross-members, in particular.

In this seventh embodiment, the deformable conveying structure 313 is substantially similar to that one described in the first embodiment, except that the deformable channel 315 is formed by three tensioning arms 319, herein arranged at 120° with respect to one another, and that said deformable conveying structure 313 comprises three belts 317, each arranged around one of the tensioning arms 319. When an object is picked up with the first handling end 309, the belts 317 together clasp this object and drive it from the first handling end 309 up to the second handling end 311.

One or more cross-member(s) 321 connect the three tensioning arms 319 together in pairs. The cross-members 321 pass outside the pipe formed by the deformable channel 315. The cross-members 321 hold the tensioning arms 319 at a substantially constant spacing distance from each other. In this case, the deformable conveying structure 313 comprises three cross-members 321 connecting the radial portions of the tensioning blocks 331 of the tensioning arms 319 together in pairs, proximate to the second handling end 311.

The first actuator deforms the deformable conveying structure 313 in a manner substantially similar to that one described in the first embodiment, except that the relative translational movement of one of the tensioning blocks 331 relative to the other tensioning blocks 331 causes a deformation of the deformable conveying structure 313 in three non-coplanar directions of the space. In this case, this deformation causes a movement of the second handling end 311 within the placement area, in the three directions of space.

In FIG. 12, the first actuator is inactive. The deformable robot 301 is not deformed.

In FIG. 13, the first actuator moves, at the first handling end 309, the tensioning block of the tensioning arm 319 shown at the bottom, to the right, with respect to the tensioning blocks of the other two tensioning arms 319. The second handling end 311 is moved accordingly, herein substantially towards the top of the figure. The deformable conveying structure 313 is deformed.

This embodiment of the device has the advantage of improving the grasp of the deformable conveying structure on the objects to be conveyed. It also allows rotating these objects uniformly, by varying the drive speeds of the belts differentially, as described hereinabove with regards to the device of FIG. 6.

Of course, the first embodiment with two tensioning arms and two belts as illustrated for example with reference to FIGS. 1 and 2, and the seventh embodiment with three tensioning arms and three belts as illustrated with reference to FIGS. 11, 12 and 13 are given for merely illustrative and non-limiting purposes: according to the same principle of deformable conveying structure, in an embodiment defined more generally, the deformable channel is formed by a plurality (two, three or more) of tensioning arms comprising a soft and flexible body, and the deformable conveying structure comprises a plurality of belts, each arranged around one of the tensioning arms. According to a particular feature of such an embodiment, the deformable conveying structure then generally comprises as many tensioning arms as belts, each tensioning arm acting as belt carrier structure.

In another variant that is not illustrated, the tensioning arms comprising a soft and flexible body are placed outside the belts and are connected together by a deformable tubular structure (manufactured for example in a soft plastic), also placed outside the belts. These belts are then carried by support means (for example, pulleys) secured to the internal surface of the tubular structure. Like before, the tensioning arms tension the belts through the tubular structure, and also transmit the deformation of the structure to the belts. These tensioning arms may be controlled to ensure a desired deformation of the tubular structure (i.e. of the deformable channel), and, consequently, a similar deformation of the belts inside said tubular structure. Hence, in such an embodiment, there is not necessarily as many tensioning arms as belts.

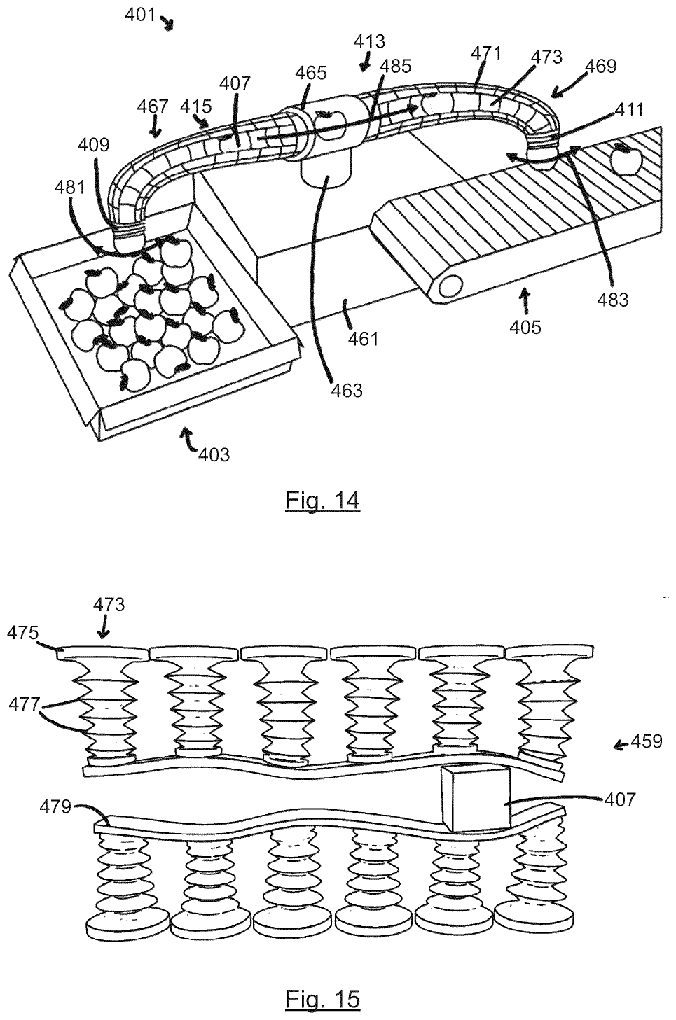

Reference is made to FIG. 14.

This figure shows a scenario of a pick-and-place device according to an eighth embodiment of the invention, in three-quarter view.

Elements that are functionally similar to those described in the first embodiment bear identical reference numerals increased by four hundreds.

In this eighth embodiment, the deformable conveying structure 413 comprises a peristaltic movement structure connected to the deformable channel 415. In this case, the peristaltic movement structure is designed so as to convey objects 407 picked up with the first handling end 409 up to the second handling end 411, as represented by a seventh arrow 485.

In this case, the picking area 403 is a tray. In this case, the placement area 405 is a table top conveyor. In this case, to simplify the explanation, the table top conveyor is shown horizontal, but said table top conveyor may be inclined. In this case, the table top conveyor is positioned over the tray.

The pick-and-place device comprises a stand 461 supporting the deformable robot 401. In this case, the stand 461 has a generally parallelepiped shape. In this case, the stand 461 is positioned between the picking area 403 and the placement area 405.

The deformable conveying structure 413 comprises a column 463, supporting the deformable channel 415. The column 463 extends according to an axis, herein a vertical axis. In this case, the column 463 is supported by the stand 461.

The deformable channel 415 comprises a sleeve 465, fitted on the column 463. In this case, the sleeve 465 is designed so as to be able to rotate about the axis of the column 463 relative to the stand 461. In this case, the sleeve 465 has a generally cylindrical shape. In this case, the sleeve 465 is hollow.

The deformable channel 415 further comprises a first deformable arm 467 and a second deformable arm 469, connected by the sleeve 465. The first deformable arm 467 has the first handling end 409 at its end opposite to the sleeve 465. The second deformable arm 469 has the second handling end 411 at its end opposite to the sleeve 465. The first deformable arm 467 deforms so as to move the first handling end 409 within the picking area 403, as represented by an eighth arrow 481. The second deformable arm 469 deforms so as to move the second handling end 411 within the placement area 405, as represented by a ninth arrow 483.

The first deformable arm 467 and the second deformable arm 469 have a generally elongate shape. In this case, each of the first deformable arm 467 and the second deformable arm 469 has a set of tubular portions 471, connected one after another. In this case, each of the first deformable arm 467 and the second deformable arm 469 has eleven tubular portions 471.

The peristaltic movement structure is accommodated in the deformable channel 415. The peristaltic movement structure connects the first handling end 409 to the second handling end 411. The peristaltic movement structure is accommodated inside the first deformable arm 467, the sleeve 465 and the second deformable arm 469.

The use, in the deformable conveying structure 413, of a soft structure, such as the peristaltic movement structure, enables the deformable robot 401 to handle objects 407 that are fragile or have variable dimensions.

The peristaltic movement structure comprises peristaltic rings 473 positioned one after another.

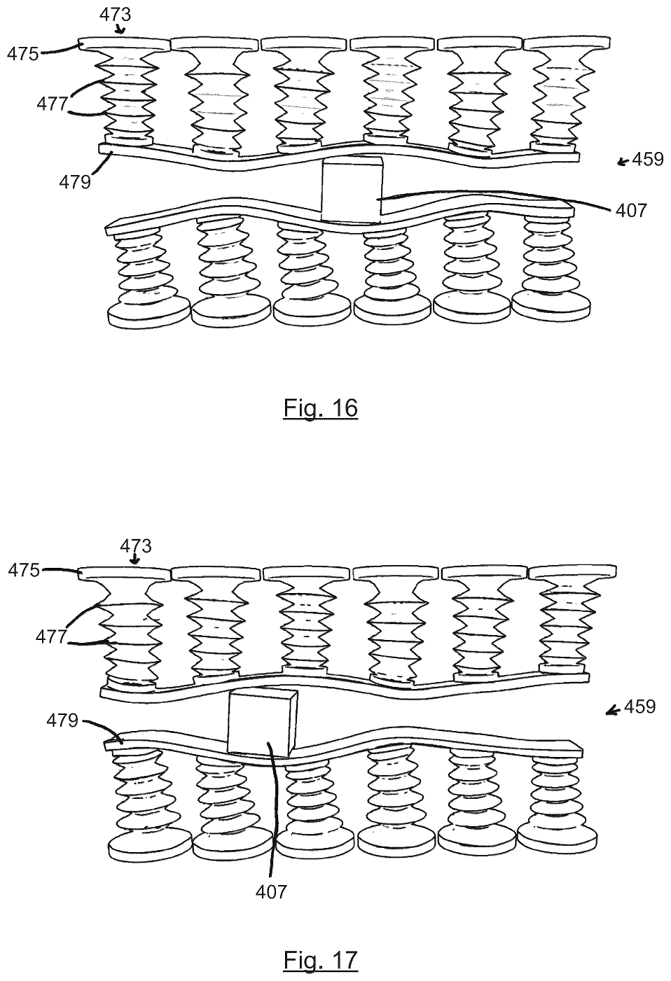

Reference is made to FIGS. 15 to 17.

These figures show the peristaltic movement structure 459 of the device of FIG. 14 in different successive steps of conveying an object 407, in an enlarged side view.

Each peristaltic ring 473 has a row of inflatable actuators 475. Each inflatable actuator 475 has a set of silicone cavities 477. When said inflatable actuator 475 inflates, said silicone cavities 477 unfold as they are filled with air. When said inflatable actuator 475 deflates, said silicone cavities 477 fold while expelling air. In this case, each inflatable actuator 475 has five silicone cavities 477. In this case, the silicone cavities 477 are generally in the form of a saucer.

The deformable conveying structure further comprises an inner duct 479 supported by the inflatable actuators 475. The inner duct 479 forms a pipe for the objects 407. The inflatable actuators 475 modify the section of the inner duct 479 by inflating one after another, as shown in FIGS. 15 to 17 for example. This deformation of the inner duct 479 exerts a constriction on the object 407 to be conveyed, so as to make said object 407 progress in the inner duct 479 by a peristaltic movement. In this case, FIGS. 15 to 17 show a progress of the object 407 from the right to the left.

The invention is not limited to the above-described embodiments, but encompasses all variants that could be considered by a person skilled in the art. In particular:
the deformable conveying structure 413 of the deformable robot 401 described in the eighth embodiment may comprise, instead of the peristaltic movement structure 459, a suction system and a blower system connected to the deformable channel 415, accommodated in the first deformable arm 467 and the second deformable arm 469, respectively;
the deformable conveying structure 413 of the deformable robot 401 described in the eighth embodiment may comprise, instead of the peristaltic movement structure 459, an eyelash mechanism moving through a coordinated flapping an object 407 in the deformable channel 415.

Although the present disclosure has been described with reference to one or more examples, workers skilled in the art will recognize that changes may be made in form and detail without departing from the scope of the disclosure and/or the appended claims.

1. A pick-and-place device, which comprises:
a deformable robot designed so as to be arranged proximate to a picking area and a placement area, the deformable robot comprising:
a first handling end, at which the deformable robot picks up an object in the picking area,
a second handling end, at which the deformable robot places an object in the placement area, the first handling end being able to be moved in the picking area, or the second handling end being able to be moved in the placement area,
a deformable conveying structure connecting the first handling end and the second handling end so as to convey an object picked up by the first handling end up to the second handling end.

2. The pick-and-place device according to claim 1, wherein the deformable conveying structure comprises a deformable channel.

3. The pick-and-place device according to claim 2, wherein the deformable channel comprises a pair of tensioning arms, held at a substantially constant distance from each other, and wherein the deformable conveying structure comprises a pair of belts, each arranged on one of the tensioning arms, the pair of belts, being able to clasp an object therebetween and to drive the latter from the first handling end up to the second handling end.

4. The pick-and-place device according to claim 3, wherein the deformable conveying structure comprises cables, positioned along the tensioning arms, and an actuator connected to said cables and designed so as to deform the deformable conveying structure by varying the tension of the cables.

5. The pick-and-place device according to claim 2, wherein the deformable channel comprises three tensioning arms, connected to each other proximate to the first handling end or the second handling end, and wherein the deformable conveying structure comprises three belts, each arranged on a respective tensioning arm, the belts being able to clasp together an object and to drive the latter from the first handling end up to the second handling end.

6. The pick-and-place device according to claim 2, which further comprises a slide and wherein the deformable conveying structure comprises a plurality of tensioning arms and an actuator connected to said slide and designed so as to deform the deformable conveying structure by translating one of the tensioning arms along the slide.

7. The pick-and-place device according to claim 2, able to modify an orientation of an object conveyed in the deformable channel.

8. The pick-and-place device according to claim 2, wherein the deformable channel comprises at least one tensioning arm and the deformable conveying structure comprises at least one belt arranged on the at least one tensioning arm, and wherein the at least one belt is deformable according to a direction transverse to a local drive direction of said belt.

9. The pick-and-place device according to claim 2, wherein the deformable conveying structure comprises a peristaltic movement structure connected to the deformable channel.

10. The pick-and-place device according to claim 9, wherein the peristaltic movement structure comprises peristaltic rings, each peristaltic ring having a row of inflatable actuators.

11. The pick-and-place device according to claim 1, wherein the first handling end or the second handling end has a flared shape.

12. The pick-and-place device according to claim 1, wherein the first handling end or the second handling end has a gripping actuator.
